(19) United States
(12) Patent Application Publication
(10) Pub. No.: US 2022/0040506 A1
(43) Pub. Date: Feb. 10, 2022

(54) Mask Device with Improved Comfort, Airflow, Humidity, and Temperature Characteristics and Providing a Means for Conducting Facial Exercises

(71) Applicant: Kamran Ansari, Tustin, CA (US)

(72) Inventor: Kamran Ansari, Tustin, CA (US)

(21) Appl. No.: 17/444,596

(22) Filed: Aug. 6, 2021

Related U.S. Application Data
(60) Provisional application No. 63/062,318, filed on Aug. 6, 2020.

(51) Int. Cl. A62B 18/00; A41D 13/11; A62B 7/10; A62B 9/00; A62B 18/08; A62B 18/02

(52) U.S. Cl. CPC A62B 18/006; A41D 13/1115; A62B 7/10; A41D 2500/30; A62B 18/08; A62B 18/025; A62B 9/00

(57) ABSTRACT

The present application describes a mask, configured to be worn on a face of an individual, that has a porous mask frame made of a polymer, one or more fans positioned on the porous mask frame, a mask covering made of one or more layers of non-woven fabric, an energy source in electrical communication with the one or more fans and positioned on at least one of the mask frame or the mask covering. Alternatively, there one or more fans may be positioned on the masking covering without the aid of the mask frame.

### CROSS-REFERENCE

The present application relies on, for priority, U.S. Patent Provisional Application No. 63/062,318, entitled “Mask Device with Improved Comfort, Airflow, Humidity, and Temperature Characteristics and Providing a Means for Conducting Facial Exercises” and filed on Aug. 6, 2020, which is herein incorporated by reference in its entirety.

### FIELD OF THE INVENTION

The present application is directed to a masking system that has numerous improved characteristics, including comfort, airflow, humidity, temperature and vocal communication characteristics. More specifically, the present application is directed toward a reusable mask frame with a plurality of components integrated therein and a disposable or single-use mask made from non-woven fabric having novel contouring to physically accommodate the reusable mask frame and help adhere the reusable mask frame to an individual's face.

### BACKGROUND OF THE INVENTION

The spread of the coronavirus referred to as SARS-CoV-2 and the subsequent COVID-19 pandemic has placed an extraordinary premium, and made critically important, the wearing of masks. Conventional surgical masks comprised of multiple layers of non-woven material, such as spunbond or melt blown polypropylene, have several variable characteristics. They are water repellent, capable of filtering out particles, including bacteria and viruses, and are useful in controlling the spread of the SARS-CoV-2 virus.

While extremely useful in battling the transmission of the SARS-CoV-2 virus, people often refuse to consistently wear masks. Reasons given include a feeling like one cannot breathe, a lack of comfort, a feeling that one's voice becomes too muffled, among other downsides. This refusal to wear masks exacerbates the spread of SARS-CoV-2 and directly leads to the severity of the pandemic.

Furthermore, for many people, safety concerns are not sufficient incentives to wear a mask. Therefore, it would be preferable for a mask to serve multiple purposes, beyond simply providing increased safety. It is also essential to improve the comfort level, and related characteristics, of masks. It is also desirable to have a mask that allow people to feel like they can breathe. It is further desirable to have a mask that allow people to feel like they can be heard when they speak.

### SUMMARY OF THE INVENTION

The present invention is directed toward multiple embodiments. In one embodiment, the claimed invention is a mask, configured to be worn on a face of an individual, comprising a porous mask frame comprising a polymer, one or more fans positioned on the porous mask frame, a mask covering comprising one or more layers of non-woven fabric and configured to form a pocket adapted to physically, releasably receive the mask frame, wherein, when the mask frame is positioned in the pocket of the mask covering, an external surface of the mask covering has a first surface curvature that defines a surface area of the pocket and a second surface curvature that defines a surface area adjacent to the pocket and wherein the first surface curvature is greater than the second surface curvature, and an energy source in electrical communication with the one or more fans and positioned on at least one of the mask frame or the mask covering, wherein the one or more fans is configured to pull air through the mask covering and toward the face of the individual. Optionally, the polymer is polyvinyl alcohol and/or forms a cooling hydrogel. Optionally, the one or more fans has a footprint of 25 mm×25 mm×5 mm or less. Optionally, the openings in the mask frame constitute at least 20% of a surface area of the mask frame.

In another embodiment, the claimed invention is a mask, configured to be worn on a face of an individual, comprising a first mask frame comprising a first polymer and having a central opening that is bounded by the polymer, a second porous mask frame comprising a second polymer, wherein the second porous mask frame is configured to fit within the central opening, one or more fans positioned on the second porous mask frame, a mask covering comprising one or more layers of non-woven fabric and configured to form a pocket adapted to physically cover the second porous mask frame, wherein, when the mask covering is positioned over the second mask frame, an external surface of the mask covering has a first surface curvature that defines a first surface area and an external surface of the first mask frame that is not covered by the mask covering has a second surface curvature that defines a surface area adjacent to the mask covering and wherein the first surface curvature is greater than the second surface curvature; and an energy source in electrical communication with the one or more fans and positioned on at least one of the first mask frame or the second mask frame, wherein the one or more fans is configured to pull air through the mask covering and toward the face of the individual. Optionally, at least one of the first polymer or second polymer is polyvinyl alcohol. Optionally, at least one of the first polymer or second polymer forms a cooling hydrogel. Optionally, the one or more fans has a footprint of 25 mm×25 mm×5 mm or less. Optionally, the openings in the second mask frame constitute 20% or more of a surface area of the second mask frame.

In another embodiment, the claimed invention is a mask, configured to be worn on a face of an individual, comprising a mask covering comprising one or more layers of non-woven fabric one or more fans positioned on the masking covering, and an energy source in electrical communication with the one or more fans and positioned on the mask covering, wherein the one or more fans is configured to pull air through the mask covering and toward the face of the individual. Optionally, the one or more fans has a footprint of 25 mm×25 mm×5 mm or less.

In another embodiment, the claimed invention is a mask, configured to be worn on a face of an individual, comprising a first mask frame comprising a first polymer and having a central opening that is bounded, at least in part, by the polymer, one or more fans positioned on sides of the central opening, a mask cover comprising one or more layers of non-woven fabric and configured to have at least one receiving section for physically receiving the one or more fans, wherein, when the one or more fans is positioned in the at least one receiving section, the one or more fans are configured to blow air from an external environment through the one or more layers of non-woven fabric and into an interior volume of the mask cover or blow air from interior volume of the mask cover through the one or more layers of non-woven fabric and into the external environment, and an energy source in electrical communication with the one or more fans and positioned on at least one of the first mask frame or a head attachment structure. Optionally, the one or more fans are positioned in a holder structure configured to pivot toward, or away from, the face of the individual. Optionally, the polymer is polyvinyl alcohol. Optionally, the polymer forms a cooling hydrogel. Optionally, the one or more fans has a footprint of 25 mm×25 mm×5 mm or less. Optionally, the one or more fans comprise two fans positioned on opposing sides of the central opening, wherein the at least one receiving section in the mask comprise two receiving sections positioned on opposing sides of the mask cover, and wherein each of the two receiving sections is configured to physically receive, and releasably attach to, each of the two fans. Optionally, the two receiving sections physically receive, and releasably attach to, each of the two fans using magnetic attraction. Optionally, the two receiving sections have magnetic susceptible material configured to be attracted to magnets positioned proximate each of the two fans. Optionally, one of the two fans is configured to blow air from the external environment through the one or more layers of non-woven fabric and into the interior volume of the mask cover and a second of the two fans is configured to blow air from the interior volume of the mask cover through the one or more layers of non-woven fabric and out to the external environment. Optionally, both of the two fans are configured to blow air from the external environment through the one or more layers of non-woven fabric and into the interior volume of the mask cover. Optionally, both of the two fans are configured to blow air from the interior volume of the mask cover through the one or more layers of non-woven fabric and out to the external environment.

### BRIEF DESCRIPTION OF THE DRAWINGS

These and other features and advantages of the present specification will be further appreciated, as they become better understood by reference to the following detailed description when considered in connection with the accompanying drawings:

FIG. 1 shows an exemplary embodiment of the mask cover and mask frame;

FIG. 2 shows another exemplary embodiment of the mask frame;

FIG. 3 shows an exemplary embodiment of the fan, holder, and holder material;

FIG. 4 shows a side view of an exemplary embodiment of the mask cover;

FIG. 5A shows an exemplary embodiment of a wearer interface configured to receive the mask frame and to be positioned on the wearer's skin;

FIG. 5B shows another view of an exemplary embodiment of a wearer interface configured to receive the mask frame and to be positioned on the wearer's skin;

FIG. 6 is a flowchart demonstrating an exemplary method of using embodiments of the mask cover and mask frame;

FIG. 7 shows another exemplary embodiment of the mask frame with the mask cover;

FIG. 8 shows another exemplary embodiment of the mask frame with the mask cover;

FIG. 9 shows another exemplary embodiment of the mask frame with the mask cover;

FIG. 10 shows another exemplary embodiment of the mask cover with integrated dehumidifying, airflow, and/or cooling elements;

FIG. 11 shows another exemplary embodiment of the mask frame without the mask cover;

FIG. 12 shows another exemplary embodiment of the mask frame without the mask cover;

FIG. 13 shows another exemplary embodiment of the mask cover configured to be positioned over the mask frames shown in FIGS. 11 and 12;

FIG. 14 is a flowchart demonstrating an exemplary method of using embodiments of the mask cover and mask frame;

FIG. 15 is another exemplary embodiment of a mask frame that can function as a means for a wearer performing facial exercises.

FIG. 16A is a side view of an exemplary embodiment of a mask cover; and

FIG. 16B is a top view of the exemplary mask cover of FIG. 16A.

### DETAILED DESCRIPTION

The masking system may be used to protect against the transmission of SARS-CoV-2 in a manner that provides the wearer with improved comfort, decreased temperature, decreased humidity, and improved vocal communication. The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “comprise” “include” and “have”, and forms thereof, are not necessarily limited to members in a list with which the words may be associated. It should be noted herein that any feature or component described in association with a specific embodiment may be used and implemented with any other embodiment unless clearly indicated otherwise.

As used herein, the indefinite articles “a” and “an” mean “at least one” or “one or more” unless the context clearly dictates otherwise.

The present application discloses multiple different embodiments. It should be appreciated that portions of the various embodiments may be combined in various manners to achieve the dehumidifying, increased air flow, improved vocal communication and/or decreased temperature objectives of the present application.

### Embodiment 1

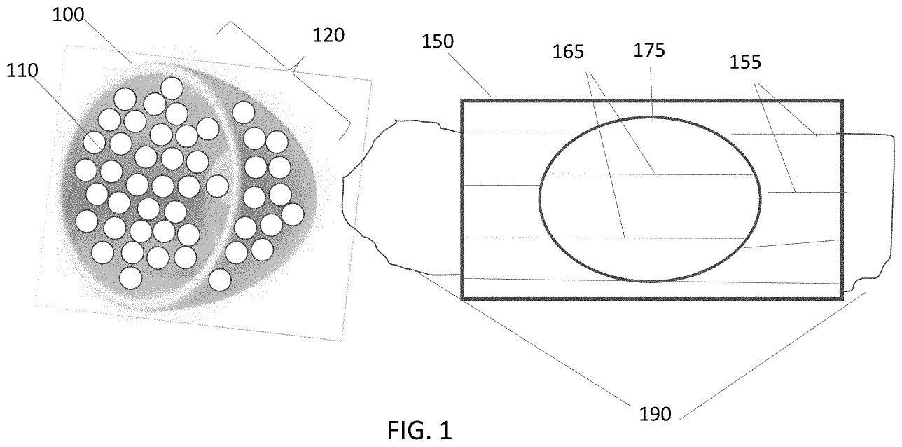

Referring to FIG. 1, a mask cover 150 and mask frame 100 are shown. The mask frame 100 is preferably made of a lightweight reusable plastic. In particular, the mask frame 100 is preferably made of polyvinyl alcohol (PVA) with a polymerization of 1500 to 2500 or a molecular weight of 60,000 to 100,000 and a hydrolyzation of 88% or greater. When formed by dissolving PVA material into demineralized water and using a conventional freeze-thaw cycle, the resulting material is a hydrogel with substantial cooling properties. In one embodiment, the formed PVA material has the ability to decrease the internal volume temperature in a range of 2 degrees Celsius to 15 degrees Celsius. The mask frame 100 is preferably in the shape of a cone, disc, or convex surface 120 with a plurality of openings 110 that yield a very porous surface. The porous surface results in at least 50% open surface area. Preferably the open surface is in a range of 30% to 90% of the total surface area of the mask frame 100. To provide improved rigidity, thin wire may be integrally formed into the mask frame 100, thereby allowing for a decreased amount of material while still maintaining the mask frame 100 sufficiently rigid and capable of holding a micro fan, as further described below.

The mask frame 100 fits within the mask cover 150 and, in particular, to the central area 175 of the mask cover 150. The mask cover 150 has ear loops 190 which extend from the two ends of the mask cover 150. The mask cover 150 is made of one or more layers of non-woven fabric, preferably fabric made by a melt-blown, spun, or combination of melt-blow or spun techniques. To enable mask expansion one or more of the layers of non-woven fabric comprise pleats 155, 165. The pleats in the central area of the mask 175 are differently formed or dimensioned relative to the pleats in the surrounding areas of the mask.

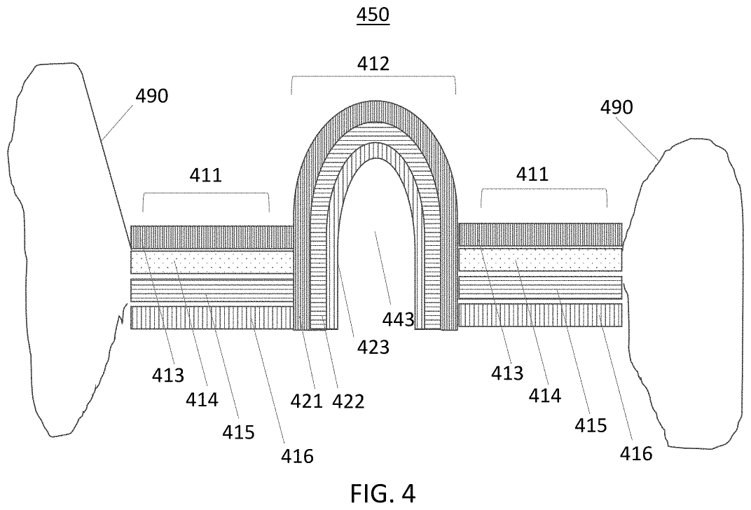

Referring to FIG. 4, the various non-woven material layers 413, 414, 415, 416 are shown for the left and right sides 411 of the mask 450. The opposing ends of the left and right sides 411 of the mask 450 are connected to strings, elastic bands, or other fabric-based members 490 that serve as a head or ear loop attachment mechanism. Positioned between, and fixedly attached to each of the sides 411, is the central area 412 of the mask 450, which is also made of multiple layers of non-woven fabric 421, 422, 423. It should be appreciated that the number of non-woven layers for the sides 411 and central area may vary from 1 to 10 or more. The central area 412 is sewn together with, or otherwise attached to, the sides 411 such that, when worn by a user or otherwise expanded, the central area 412 has a greater curvature to its external surface than the sides 411. This results in side surfaces 411 having a more shallow (less curved) convex surface when worn when compared to the central area 412, which will have a deeper (more curved) convex surface when worn. It should be appreciated that the outside curvature of the mask frame is preferably similar to the outside curvature of the central area 412, thereby enabling a snug fit between the outside surface of the mask frame and the inside surface of the central area 412.

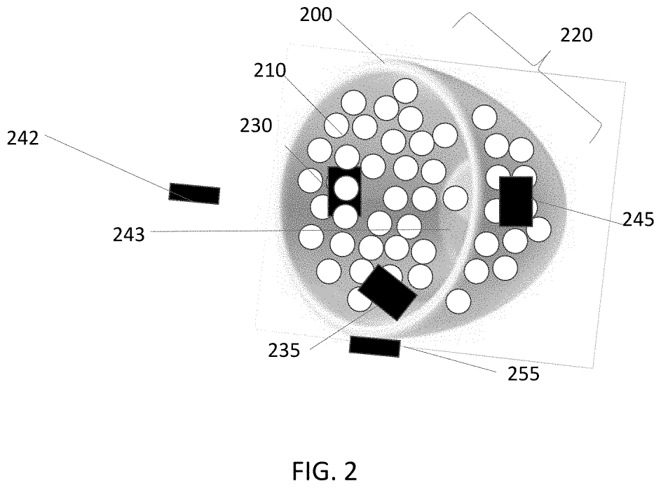

Referring back to FIG. 2, the mask frame 200 has a cone, disc, or otherwise convex shaped structure 220 that defines an interior volume 243. Proximate to one or more of the plurality of voids or openings 210 is at least one micro-fan 245 that is in electrical communication with an energy source 255 that is activated by a power switch. Optionally, a mini-microphone 235 is positioned in the interior volume 243, or external to the interior volume 243. The mini-microphone 235 is electrically connected to an amplifier and, in turn, to the energy source 255 and/or the speaker 242. The speaker 242 may be positioned on an external surface of the mask frame 200 or a surface of the mask cover 250. The amplifier may be further programmed to modulate any analog data, indicative of the wearer's voice, in order to create different vocal effects, from no modulation (thereby yielding the speaker's natural voice), to increasing, decreasing, and/or shifting the bass, treble, phonation, pitch, loudness, and/or rate to create various vocal effects.

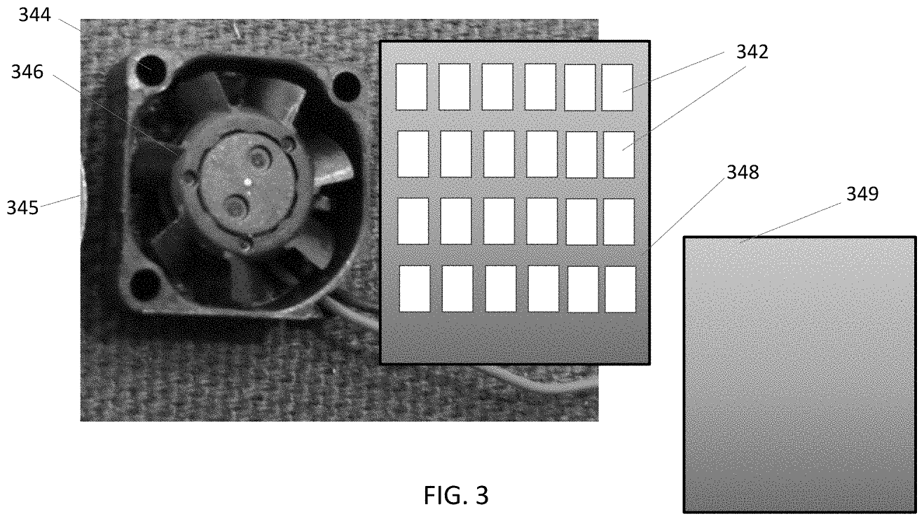

In preferred embodiments, as shown in FIG. 3, at least one small fan 345 is coupled to the mask frame 200 and configured to pull air through the non-woven layers of the mask cover 150 and into the interior volume 243 of the mask frame 200. Preferably the fan 345 comprises a frame 244 coupled to a plurality of circularly positioned blades 346. The fan 345 has a footprint in a range of 5 mm×5 mm×1 mm to 30 mm×30 mm×10 mm. More preferably, the fan has a length that is not greater than 20 mm, a width that is not greater than 20 mm, and a thickness that is not greater than 5 mm. Most preferably, the fan has a length that is not greater than 15 mm, a width that is not greater than 15 mm, and a thickness that is not greater than 5 mm. Preferably the fan generates an airflow in a range of 0.1 cubic feet per minute (CFM) to 1 CFM, more preferably 0.3CFM to 0.6CFM and most preferably 0.4 CFM to 0.5 CFM, based on a DC voltage of 5V and a current of 0.06 amps and without generating more noise than 30 dBA. The fan 345 is electrically coupled to an energy source, 255, such as a battery. In another embodiment, the fan may be a piezo-electric fan or any fan capable of operating on low voltage and in a small footprint.

In one embodiment, a holder 348, defined by a housing having plurality of holes 342, thereby making it porous, is positioned proximate to the fan 345. The holder 348 is configured to receive into the housing volume an enclosed bag of material 349 that acts as a moisture absorber or desiccant. The material may be any known desiccant, including various salts, CaCl, NaCl, or silica-based compositions. Further the bag of material may further comprise compositions that provides or absorb scents, thereby helping to deodorize air internal to the mask frame. When air is pulled in by the fan 345 through the non-woven material of the mask cover, it also passes through the bag of material 349 being held in the holder 348, which, in turn dehumidifies and deodorizes the air. As a result, humidity decreases, relative to the humidity level in the inside of the mask without the facial interface (described below), fan, or moisture absorber, by at least 5%, preferably by 10%, 20%, 30%, 40%, 50%, 60%, 70%, 80%, or 90% or any numerical increment between 5% and 95%. Additionally, as a result, airflow into the mask increases, relative to the airflow into the mask caused by the normal breathing of the wearer without the facial interface (described below), fan, or moisture absorber, by at least 5%, preferably by 10%, 20%, 30%, 40%, 50%, 60%, 70%, 80%, or 90% or any numerical increment between 5% and 95%.

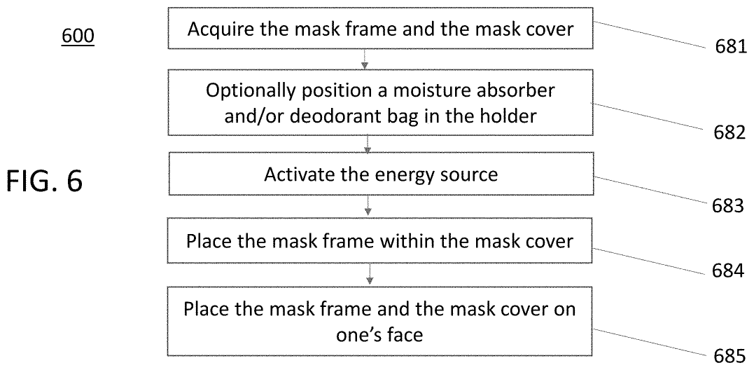

Operationally, referring to FIG. 6, a user acquires the mask frame and mask cover 681. After insuring the energy source, such as a battery, is present and positioning a moisture absorber and/or deodorant bag in the holder 682, the user activates the energy source 683, places the mask frame within the central area of the mask cover 684, and then places the mask cover, together with the mask frame, onto his or her face, preferably adjusting the side attachment strings around his or her ears.

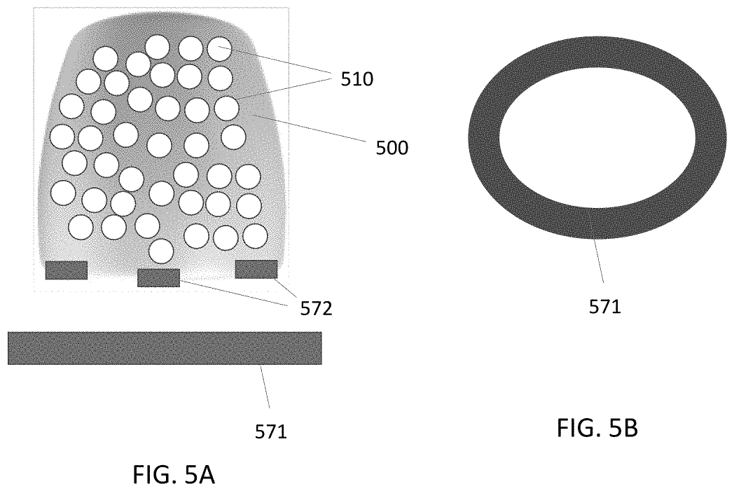

Referring to FIGS. 5A and 5B, in another embodiment, the mask frame 500 with its various openings 510 is configured to removably connect to a face interface 571 using footings 572 which are insertable into the face interface 571. Alternatively, the face interface 571 may have footings which are insertable or connectable to the mask frame 500. In one embodiment, the face interface 571 is a fully enclosed or partially enclosed oval or elliptical structure that, when positioned on the wearer's face, encircles the wearer's mouth. Preferably, the facial interface is made of a cooling hydrogel material, such as the PVA disclosed above. Accordingly, when positioned against the wearer's face, the cooling hydrogel helps make the wearer feel like the internal mask temperature is less than what it would otherwise be without the PVA material. In particular, the use of a cooling hydrogel, such as the PVA described above, causes the temperature to decrease, relative to the temperature level in the inside of the mask without the patient interface, fan, or moisture absorber, by at least 5%, preferably by 10%, 20%, 30%, 40%, 50%, 60%, 70%, 80%, or 90% or any numerical increment between 5% and 95%.

### Embodiment 2

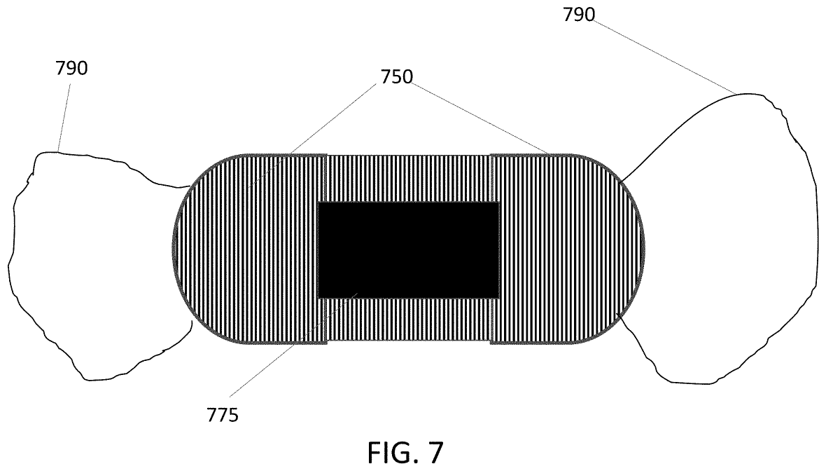

Referring to FIGS. 7-9, in another embodiment, a reusable mask frame 750, 850, 950 is formed from a lightweight reusable plastic. In particular, the mask frame 750, 850, 950 is preferably made of polyvinyl alcohol (PVA) with a polymerization of 1500 to 2500 or a molecular weight of 60,000 to 100,000 and a hydrolyzation of 88% or greater. When formed by dissolving PVA material into demineralized water and using a conventional freeze-thaw cycle, the resulting material is a hydrogel with substantial cooling properties. In one embodiment, the formed PVA material has the ability to decrease the surface temperature of a wearer's skin (since the mask frame 750, 850, 950 is adapted to be positioned against the wearer's skin) in a range of 2 degrees Celsius to 15 degrees Celsius. The mask frame 100 is preferably slightly curved with only one central opening (the periphery of which is surrounded by the mask frame material) over which a mask cover 775 is positioned. The mask cover 775 may be made of the same non-woven fabric as discussed above. Head attachment means, such as the strings or elastic bands 790 adapted to fit around the wearer's ears, are attached to the two opposing ends of the polymer-based mask frame 750.

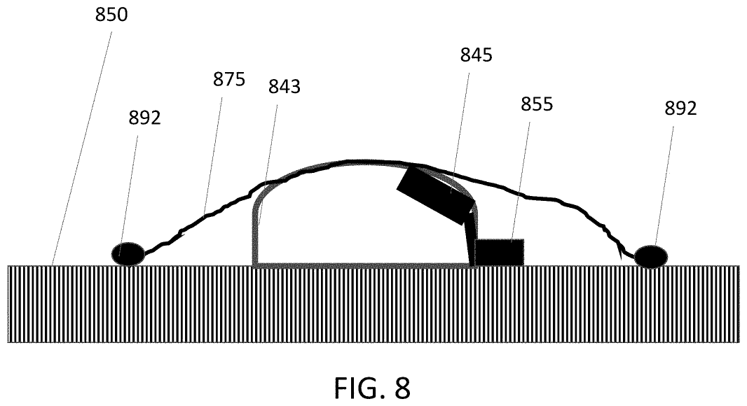

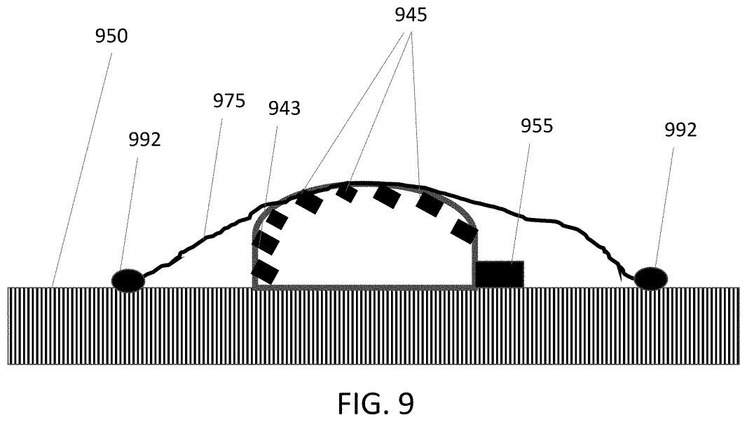

Viewing the embodiment from the side, as shown in FIG. 8, the mask frame 850 has attachment points 892 to which the mask cover 875 may attach. The attachment points may comprise snaps, elastic connectors, hooks, male/female connectors, or any other conventional attachment mechanism. The mask cover 875 extends over a convex surface 843 which may be made from porous polymer material, as described above in relation to FIGS. 1-5. Positioned on the inside or outside of the convex surface 843 is at least one fan 845 in electrical communication with an energy source 855 and in airflow communication with a holder having a moisture absorber and/or deodorant source as described above. Preferably, the convex surface 843 is formed to have a friction fit in the central area formed within the mask frame 850. When worn, the convex surface 843 has a greater degree of curvature than the mask frame 850. Alternatively, as shown in FIG. 9, the mask frame 950, friction fit with the porous convex surface 943, and covered by a mask cover 975 which is attached to the mask frame 950 at connection points 992, also has a plurality of micro-fans 945 integrated into the convex surface 943. The array of micro-fans may individually provide for a very small flow rate, such as less than 0.1 cfm, and use a very small amount of current, but when put together in an array, provide for sufficient air flow.

As a result, humidity decreases, relative to the humidity level in the inside of the mask without the mask frame, fan, or moisture absorber, by at least 5%, preferably by 10%, 20%, 30%, 40%, 50%, 60%, 70%, 80%, or 90% or any numerical increment between 5% and 95%. Additionally, as a result, airflow into the mask increases, relative to the airflow into the mask caused by the normal breathing of the wearer without the mask cover, fan, or moisture absorber, by at least 5%, preferably by 10%, 20%, 30%, 40%, 50%, 60%, 70%, 80%, or 90% or any numerical increment between 5% and 95%. Further, the use of a cooling hydrogel, such as the PVA described above, causes the temperature to decrease, relative to the temperature level in the inside of the mask without the mask frame, fan, or moisture absorber, by at least 5%, preferably by 10%, 20%, 30%, 40%, 50%, 60%, 70%, 80%, or 90% or any numerical increment between 5% and 95%.

### Embodiment 3

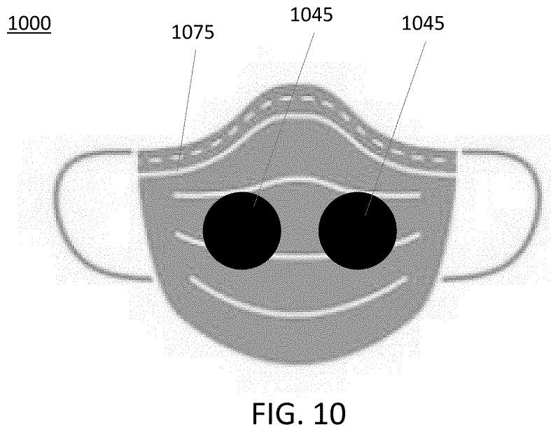

Referring to FIG. 10, the mask 1000 may comprise a mask covering 1075 with a plurality of non-woven fabric layers, as described above. Inside the mask covering 1075, either within or between the plurality of non-woven fabric layers or positioned between the internal surface of the mask covering 1075 and the wearer's face are dehumidifying and/or air flow management components 1045. The dehumidifying and/or air flow management components 1045 may comprise any of the fan configurations described above, together with the electrical source, and/or a holder with moisture absorber and/or deodorizing material, as described above.

### Embodiment 4

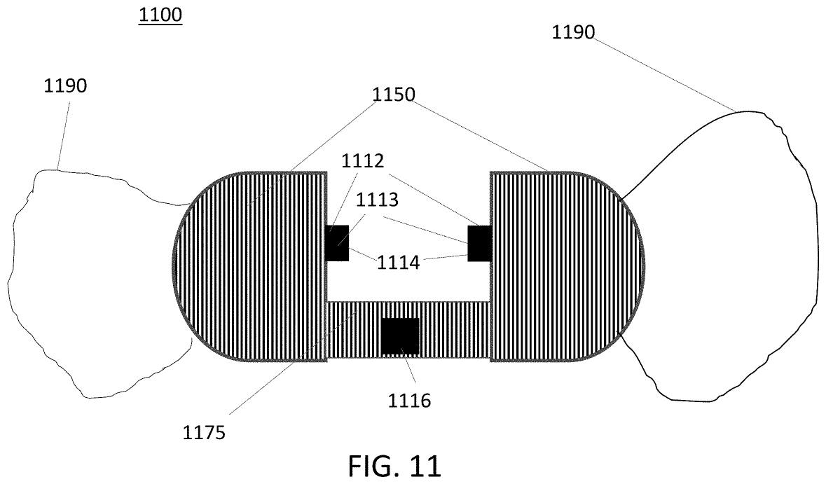

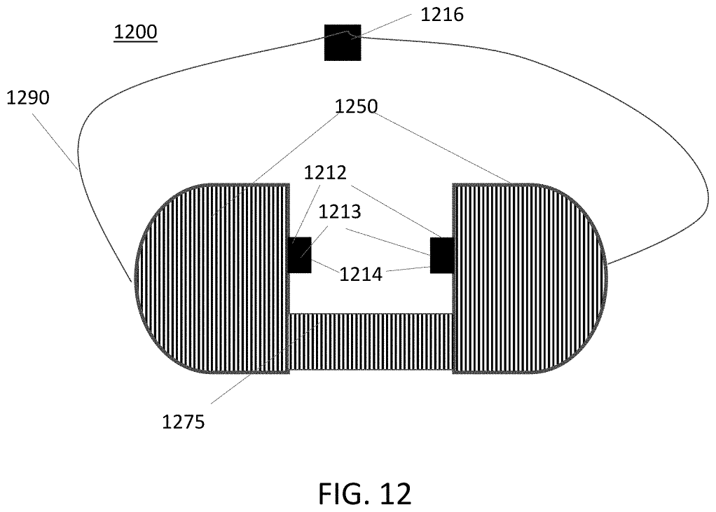

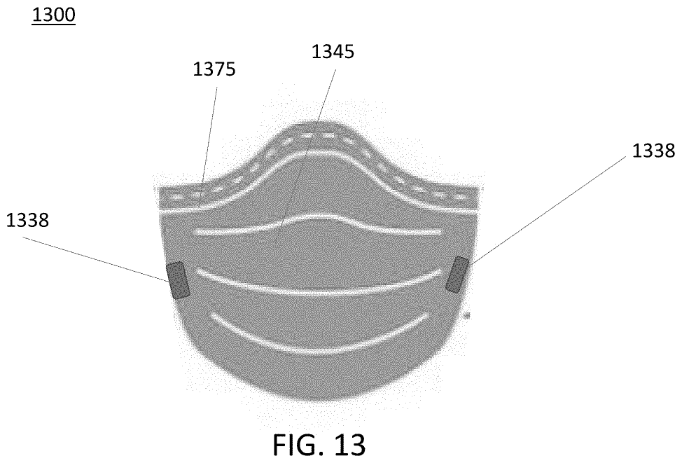

Referring to FIGS. 11-14, in another embodiment, a reusable mask frame 1100, 1200 is formed from a lightweight reusable plastic. In particular, the mask frame 1100, 1200 is preferably made of polyvinyl alcohol (PVA) with a polymerization of 1500 to 2500 or a molecular weight of 60,000 to 100,000 and a hydrolyzation of 88% or greater. When formed by dissolving PVA material into demineralized water and using a conventional freeze-thaw cycle, the resulting material is a hydrogel with substantial cooling properties. In one embodiment, the formed PVA material has the ability to decrease the surface temperature of a wearer's skin (since the mask frame 1100, 1200 is adapted to be positioned against the wearer's skin) in a range of 2 degrees Celsius to 15 degrees Celsius. The mask frame 1100, 1200 is preferably made of three sections, a left and right section 1150 configured to be positioned on the wearer's left and right cheeks, which are connected by a base section 1175 that is configured to extend over a wearer's chin. The mask frame 1100, 1200 is slightly curved with only one central opening (the periphery of which is surrounded by the mask frame material on only three side with the fourth/top side having no PVA material) over which a mask cover 1300 is positioned. The mask cover 1300 may be made of the same non-woven fabric 1375 as discussed above. Head attachment means, such as the strings or elastic bands 1190, 1290 adapted to fit around the wearer's ears or around the entirety of the wearer's head, are attached to the two opposing ends of the polymer-based mask frame 1150, 1250.

Referring to the embodiment in FIG. 11, a first fan 1113 is positioned on the right side of the mask and a second fan 1113 is positioned on the left side of the mask. Both a preferably held in a left and right flexible holder, member, or extension 1112 that are configured to receive and hold the first and second fans 1113. The left and right flexible holder, member, or extension 1112 preferably have a flexible material, such as aluminum or tin, that extends from the holder structure to the left and right mask frame section 1150. The left and right flexible holder, member, or extension 1112 allow a wearer to move the left and right flexible holder, member, or extension 1112 toward or away from the wearer's face, pivoting it around where the left and right flexible holder, member, or extension 1112 physically contact the mask frame 1100, 1200. As discussed below, this permits a wearer to more comfortably position the mask cover 1300. The holders 1112 and/or fans 1113 preferably have an attachment mechanism, such as small magnet, attached to the opposing, distal or side ends. As further discussed below, this attachment mechanism allows the mask cover 1300 to easily attach to, and detach from, the mask frame 1100, 1200 by inserting the fans 1113 and holders 1112 into receiving sections having magnetically susceptible material positioned therein. An energy source 1116, such as a battery and circuit capable of delivering a current in a range of 0.005 to 1 amp to each of the fans, is positioned in the mask frame 1100, 1200 itself, such as the mask sections 1150, 1175, or on or within the head attachment mechanism 1190.

Once a wearer puts on the reusable mask frame 1100, 1200, the wearer may then put on a disposable mask cover 1300 which may be made from any material capable of filtering particles, such as viruses, having diameter sizes of 50 nanometers or more, and/or any non-woven fabric 1375 and may have pleats 1345 to allow the mask cover to expand horizontally and/or vertically, depending on how the pleats 1345 are formed. The mask cover 1300 has receiving sections 1338, such as a pocket, on the left and right sides configured to receive the fans 1113, 1213 and/or holders 1112, 1212. The interiors of the receiving sections 1338 are preferably configured to fully cover and encompass the fans 1113, 1213 and/or holders 1112, 1212, which, in turn, serve to fix the mask cover 1300 to the mask frame 1100, 1200. The interiors of the receiving sections 1338 are preferably configured to friction fit the fans 1113, 1213 and/or holders 1112, 1212 or to have magnetically susceptible material which may be attracted to, and held in place, by magnets positioned on or proximate to the fans 1113, 1213 and/or holders 1112, 1212.

The fans 1113 are preferably configured to generate cross ventilation through the interior of the mask cover 1300 and, therefore, when positioned in the receiving sections 1338 are separated from the interior of the mask cover 1300 and the wearer's mouth by the filtering material 1375. Specifically at least one of the right or left fans 1113 is configured to blow air from the interior of the mask cover 1300, through the filtering material 1375, to the outside environment and at least one of the right or left fans 1113 is configured to blow air from environment, through the filtering material 1375, into the interior of the mask cover 1300. Alternatively, the fans may both be configured to drive air from the environment, through the filtering material 1375, into the interior of the mask cover 1300. Specifically, both of the right or left fans 1113 are configured to blow air from the environment, through the filtering material 1375, into the interior of the mask cover 1300. Alternatively, the fans may both be configured to drive air from the interior of the mask cover 1300, through the filtering material 1375, out to the environment. Specifically, both of the right or left fans 1113 are configured to blow air from the interior of the mask cover 1300 out to the external environment.

As a result, the build-up of humidity in the mask cover decreases, relative to the humidity level in the inside of the mask without the fans or a moisture absorber (as described above) by at least 5%, preferably by 10%, 20%, 30%, 40%, 50%, 60%, 70%, 80%, or 90% or any numerical increment between 5% and 95%. Additionally, as a result, airflow into the mask increases, relative to the airflow into the mask caused by the normal breathing of the wearer without the fans or a moisture absorber (as described above), by at least 5%, preferably by 10%, 20%, 30%, 40%, 50%, 60%, 70%, 80%, or 90% or any numerical increment between 5% and 95%. Further, the use of a cooling hydrogel, such as the PVA described above, causes the temperature to decrease, relative to the temperature level in the inside of the mask without the fans or a moisture absorber (as described above), by at least 5%, preferably by 10%, 20%, 30%, 40%, 50%, 60%, 70%, 80%, or 90% or any numerical increment between 5% and 95%.

It should be appreciated that the reusable mask frame can be porous or have non-contiguous surfaces, thereby creating a lighter reusable mask frame with more air flow to the wearer. More specifically, the reusable mask frame may have an external surface that is substantially contiguous such that it covers the entirety of the wearer's right or left cheeks, jaw and/or chin when worn or an external surface that is porous, has spaces, has holes, or is otherwise non-contiguous such that portions of the wearer's right or left cheeks, jaw, and/or chin are exposed. It should further be appreciated that some wearers may be very active and the attachment of the fans/holders into the receiving portions of the mask (via a friction fit or magnetic attachment) may not be sufficient to keep the mask in place. As such, in one embodiment, the reusable mask may have protrusions or extensions around which the mask cover may extend through, snaps extending out from the surface of the reusable mask and attaching to complementary snaps on the mask cover, additional magnets positioned on the surface of the reusable mask and configured to attach to magnetically susceptible material to mask covers, or clips on the surface of the reusable mask and configured to attach to protrusions or extensions on the mask covers.

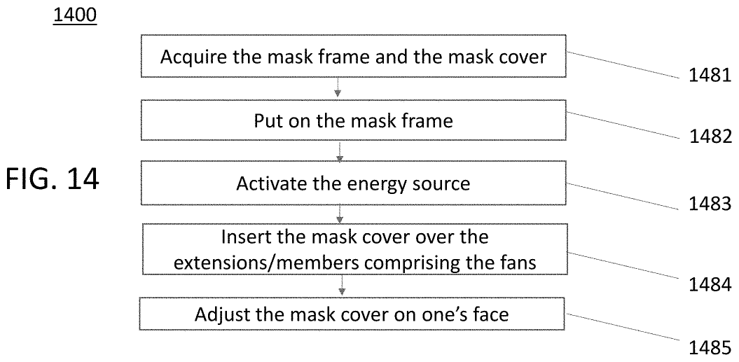

Operationally, referring to FIG. 14, a user acquires the mask frame and mask cover 1481. After insuring the energy source, such as a battery, is present, the user puts on the mask frame 1482 and activates the energy source 1483. The wearer places the mask cover over the fans and/or fan holders within the mask cover 1484 by positioning the fans and/or fan holders into the receiving sections of the mask cover and then adjusts the mask cover on one's face 1485.

### Embodiment 5

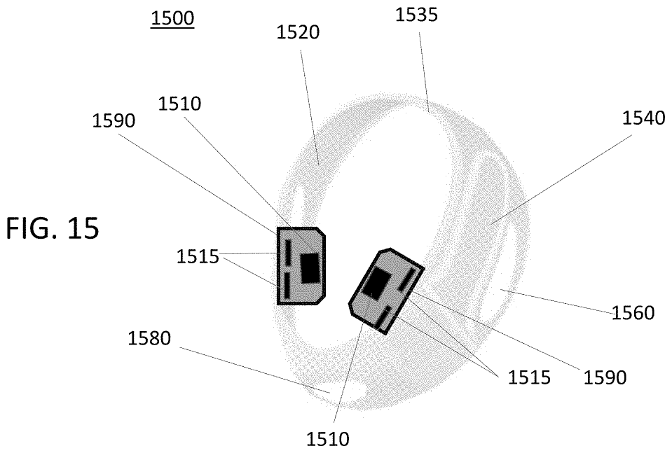

In another embodiment, the reusable mask frame 1500 is designed to provide wearers with a means for performing facial exercises, thereby making the safety device into both a safety and beauty device. Referring to FIG. 15, a reusable mask frame 1500 in the form of a facial chin strip defined by a generally curved strip of material configured to encircle the wearer's head is shown. The mask frame 1500 includes a space, void or opening 1580 to receive the wearer's chin. The frame 1500 has a thickness and form configured to extend partially across the wearer's chin and jaw and openings 1560 on a first side and on the opposing side adapted to receive the wearer's ear and have it extend out from the mask frame 1500. Attached to the mask frame substrate 1520 are flaps or extensions 1590 configured to extend inward toward each other and partially cover a wearer's cheeks. Preferably the flaps or extensions 1590 are of a less flexible or less elastic material than the mask frame substrate 1520 and have mounted thereon fans, as described above, 1510, and releasable connection points 1515, such as magnets, snaps or male/female connectors, on each of the flaps and configured to releasably receive the mask cover. The mask frame substrate 1520 comprises tightening mechanisms, such as Velcro strips 1540 which, when pulled in a given direction, will tighten the substrate 1520 around the wearer's head. In one embodiment the fans 1510 are hinged to the flaps or extensions 1590 such that they can be folded up (such that the fans 1510 extend outward from the wearer's face) or folded down (such that the fans 1510 are folded and extend in parallel to the wearer's face). Further preferably, each flap 1590 is at least partially foldable so that, while rigid, the flap 1590 can be at least partially curved or contoured to the face of the wearer such that, once contoured, the flap 1590 retains the new contoured structure. Other features, as discussed above, also apply here, including how the mask cover fits onto, and connects to, the reusable mask frame 1500.

Preferably, the wearer is instructed to conduct facial exercises while wearing the mask frame 1500. A first exercise comprises extending one's jaw up and down while wearing the mask frame 1500. A second exercise comprises inflating one's cheeks while wearing the mask frame 1500 such that the cheeks are pushing against the mask frame flaps 1590.

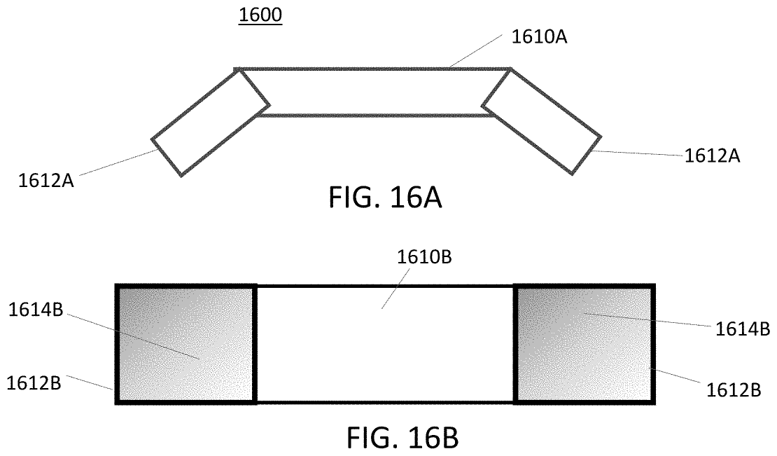

In another embodiment, referring to FIGS. 16A and 16B, the mask cover 1600 may be a clear plastic shield 1610A, 1610B adapted to be positioned over the wearer's mouth with filter material 1614B within frames on the left and right sides 1612A, 1612B extending downward to the mask frame. The filter material 1614B is preferably attached to clear plastic frames 1612A, 1612B having four sides and pivotally connected to the clear plastic shield 1610A, 1610B. The space defined by the four sides 1612A, 1612B is covered by porous material capable of allowing air to flow through, yet trap harmful particles or pollutants. The sides of the frames 1612A, 1612B extending away from the clear plastic shield 1610A, 1610B have a connection mechanism, such as a latch, hook, magnetic material, etc. that can attach to the reusable mask frame.

The above examples are merely illustrative of the many applications of the system of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

1. A mask, configured to be worn on a face of an individual, comprising:
a porous mask frame comprising a polymer;
one or more fans positioned on the porous mask frame;
a mask covering comprising one or more layers of non-woven fabric and configured to form a pocket adapted to physically, releasably receive the mask frame, wherein, when the mask frame is positioned in the pocket of the mask covering, an external surface of the mask covering has a first surface curvature that defines a surface area of the pocket and a second surface curvature that defines a surface area adjacent to the pocket and wherein the first surface curvature is greater than the second surface curvature; and
an energy source in electrical communication with the one or more fans and positioned on at least one of the mask frame or the mask covering, wherein the one or more fans is configured to pull air through the mask covering and toward the face of the individual.

2. The mask of claim 1, wherein the polymer is polyvinyl alcohol.

3. The mask of claim 1, wherein the polymer forms a cooling hydrogel.

4. The mask of claim 1, wherein the one or more fans has a footprint of 25 mm×25 mm×5 mm or less.

5. The mask of claim 1, wherein openings in the mask frame constitute at least 20% of a surface area of the mask frame.

6. A mask, configured to be worn on a face of an individual, comprising:
a first mask frame comprising a first polymer and having a central opening that is bounded by the polymer;
a second porous mask frame comprising a second polymer, wherein the second porous mask frame is configured to fit within the central opening;
one or more fans positioned on the second porous mask frame;
a mask covering comprising one or more layers of non-woven fabric and configured to form a pocket adapted to physically cover the second porous mask frame, wherein, when the mask covering is positioned over the second mask frame, an external surface of the mask covering has a first surface curvature that defines a first surface area and an external surface of the first mask frame that is not covered by the mask covering has a second surface curvature that defines a surface area adjacent to the mask covering and wherein the first surface curvature is greater than the second surface curvature; and
an energy source in electrical communication with the one or more fans and positioned on at least one of the first mask frame or the second mask frame, wherein the one or more fans is configured to pull air through the mask covering and toward the face of the individual.

7. The mask of claim 6, wherein at least one of the first polymer or second polymer is polyvinyl alcohol.

8. The mask of claim 6, wherein at least one of the first polymer or second polymer forms a cooling hydrogel.

9. The mask of claim 6, wherein the one or more fans has a footprint of 25 mm×25 mm×5 mm or less.

10. The mask of claim 6, wherein openings in the second mask frame constitute 20% or more of a surface area of the second mask frame.

11. (canceled)

12. A mask, configured to be worn on a face of an individual, comprising:
a first mask frame comprising a first polymer and having a central opening that is bounded, at least in part, by the polymer;
one or more fans positioned on sides of the central opening;
a mask cover comprising one or more layers of non-woven fabric and configured to have at least one receiving section for physically receiving the one or more fans, wherein, when the one or more fans is positioned in the at least one receiving section, the one or more fans are configured to blow air from an external environment through the one or more layers of non-woven fabric and into an interior volume of the mask cover or blow air from interior volume of the mask cover through the one or more layers of non-woven fabric and into the external environment; and
an energy source in electrical communication with the one or more fans and positioned on at least one of the first mask frame or a head attachment structure.

13. The mask of claim 12, wherein the one or more fans are positioned in a holder structure configured to pivot toward, or away from, the face of the individual.

14. The mask of claim 12, wherein the polymer is polyvinyl alcohol.

15. The mask of claim 12, wherein the polymer forms a cooling hydrogel.

16. The mask of claim 12, wherein the one or more fans has a footprint of 25 mm×25 mm×5 mm or less.

17. The mask of claim 12, wherein the one or more fans comprise two fans positioned on opposing sides of the central opening, wherein the at least one receiving section in the mask comprise two receiving sections positioned on opposing sides of the mask cover, and wherein each of the two receiving sections is configured to physically receive, and releasably attach to, each of the two fans.

18. The mask of claim 17, wherein the two receiving sections physically receive, and releasably attach to, each of the two fans using magnetic attraction.

19. The mask of claim 18, wherein the two receiving sections have magnetic susceptible material configured to be attracted to magnets positioned proximate each of the two fans.

20. The mask of claim 17, wherein one of the two fans is configured to blow air from the external environment through the one or more layers of non-woven fabric and into the interior volume of the mask cover and a second of the two fans is configured to blow air from the interior volume of the mask cover through the one or more layers of non-woven fabric and out to the external environment.

21. The mask of claim 17, wherein both of the two fans are configured to blow air from the external environment through the one or more layers of non-woven fabric and into the interior volume of the mask cover and blow air from the interior volume of the mask cover through the one or more layers of non-woven fabric and out to the external environment.

22. (canceled)
